(19) United States
(12) Patent Application Publication
(10) Pub. No.: US 2026/0117728 A1
(43) Pub. Date: Apr. 30, 2026

(54) HEAT SHIELD WITH RECESSED DUAL-EXPANSION NOZZLE, AND VEHICLE INCLUDING THE SAME

(71) Applicant: STOKE Space Technologies, Inc., Kent, WA (US)

(72) Inventors: Patrick Ryan Ball, Seattle, WA (US); Matthew Michael Dethlefsen, Normandy Park, WA (US); Thomas Ryan McCullough, Seattle, WA (US)

(21) Appl. No.: 19/131,710

(22) PCT Filed: Aug. 8, 2024
(86) PCT No.: PCT/US2024/041511

§ 371 Date: May 21, 2025

Related U.S. Application Data
(60) Provisional application No. 63/518,790, filed on Aug. 10, 2023.

(51) Int. Cl. F02K 9/97; F02K 9/86

(52) U.S. Cl. CPC F02K 9/972; F02K 9/86

(57) ABSTRACT

A dual-expansion nozzle includes a throat, a first expansion section extending downstream of the throat, and a second expansion section extending downstream of the first expansion section. An inflection point is defined where the first expansion section meets the second expansion section. The first expansion section has a first contour designed for optimal performance throughout a first altitude range. The second expansion section has a second contour designed for optimal performance throughout a second altitude range. The first altitude range and the second altitude range are separated by a third altitude range. Also disclosed is an engine including the dual-expansion nozzle, a heat shield into which at least portions of the nozzle are recessed, and a vehicle including the nozzle.

### CROSS-REFERENCE TO RELATED APPLICATION

This application claims priority to U.S. Provisional Patent Application No. 63/518,790, filed on Aug. 10, 2023, the contents of which are incorporated by reference herein in their entirety.

### TECHNICAL FIELD

The present disclosure generally relates to propulsion systems having exhaust nozzles. The present disclosure more particularly relates to a novel dual-expansion nozzle, an engine including the nozzle, a heat shield into which the nozzle is recessed, and a vehicle including the nozzle.

### BACKGROUND

Aircraft-like reusability for rockets has long been the “holy grail” of rocketry due to the potential for large cost benefits. The ability to recover and rapidly reuse an upper stage rocket of a multi-stage rocket system (e.g., the second stage rocket of a two-stage rocket system) remains a significant technical gap that has not yet been achieved. The recovery and rapid reuse of an upper stage rocket is challenging due to the performance penalties associated with increased structural mass required for withstanding the harsh atmospheric reentry environment and for controllably landing the vehicle at a precise location.

Achieving controlled landing requires the ability to maneuver during atmospheric reentry and descent. The single bell nozzle engines traditionally used for upper stage rockets have limitations that prevent their use as propulsive landing systems. Among other things, these single bell nozzle engines are typically optimized for efficiency at high altitude (e.g., in the vacuum of space) and would therefore experience poor performance during atmospheric reentry and landing operations at lower altitudes.

There are several known rocket nozzles designed to operate efficiently across a wider range of altitudes than conventional single bell nozzles. One example is the dual-bell nozzle. Referring to FIG. 1, a prior art rocket engine 218 includes a high-pressure chamber 264 (e.g., a combustion chamber) and a dual-bell nozzle 210. The dual-bell nozzle 210 includes a throat 266 that gas from the high-pressure chamber 264 flows through, a first expansion section 268 downstream of the throat 266, a second expansion section 270 downstream of the first expansion section 268, and an inflection point 272 defined where the first expansion section 268 meets the second expansion section 270.

Referring still to FIG. 1, the contour of the first expansion section 268 is designed such that the first expansion section 268 performs optimally (e.g., provides a constant momentum thrust) within a first altitude range R_{low} (i.e., a low altitude range) (see FIG. 4), and the contour of the second expansion section 270 is designed such that the second expansion section 270 performs optimally within a second altitude range R_{high} (i.e., a high altitude range) (see FIG. 4). Referring to FIG. 2, during operation in the first altitude range R_{low}, the inflection point 272 forces the plume 300 to separate from the nozzle wall, resulting in constant momentum thrust at the exit of the first expansion section 268 and reducing uncertainty in the separation location of the plume 300 during operation within the first altitude range R_{low}. Referring to FIG. 3, during travel from the first altitude range R_{low} to the second altitude range R_{high}, the atmospheric pressure decreases and the plume 300 expands until it finally transitions and attaches to the wall of the second expansion section 270 downstream of the inflection point 272. Once the plume 300 is attached to the second expansion section 270 and the nozzle exit pressure exceeds ambient pressure, the higher effective area ratio results in increased performance for the remainder of the travel within the second altitude range R_{high}.

Referring to FIG. 4, the prior art contemplates use of a dual-bell nozzle 210 in connection with the lower stage rocket 318 of a two-stage rocket system 224 (shown), or in connection with a single-stage-to-orbit (SSTO) rocket (not shown). In the illustrated prior art embodiment, the dual-bell nozzle 210 is disposed at the aft end of a lower stage rocket 318 that operates within a first altitude range R_{low} during liftoff and initial ascent, and within a second altitude range R_{high} until separation of the lower stage rocket 318 and the upper stage rocket 222. The first altitude range R_{low} extends between sea level and a first threshold altitude Alt₁, and the second altitude range R_{high} extends between the first threshold altitude Alt₁ and a maximum mission altitude Altₘₐₓ. In the prior art, the first threshold altitude Alt₁ is typically in the range from 5 km to 20 km from sea level, and the maximum mission altitude Altₘₐₓ is typically in the range from 60 km to 100 km from sea level.

Despite the above-described altitude compensating features, the prior art dual-bell nozzle 210 has been plagued by problems and concerns that have prevented its use in rockets and other space vehicles. Notably, it has been difficult to design a dual-bell nozzle 210 that smoothly transitions from the low altitude mode (FIG. 2) to the high altitude mode (FIG. 3) without a significant reduction in nozzle performance. A smooth transition is critical because any unsteadiness caused by the plume 300 attaching and detaching on the nozzle wall may cause excessive structural loads or generate lateral forces which impair the attitude control capability of the vehicle. Efforts to control this transition have been the focus of studies for decades. The lack of a suitable solution is one of the primary reasons dual-bell nozzles are not used today.

Another problem is that the prior art dual-bell nozzle 210 is sub-optimal for operation solely in the first altitude range R_{low} and also sub-optimal for operation solely in the second altitude range R_{high}. The dual-bell nozzle 210 may result in nozzle performance that is worse at the beginning of the second altitude range R_{high} than a conventional single-bell nozzle that is designed to an optimal average performance throughout the full mission altitude range (i.e., throughout the first and second altitude ranges R_{low}, R_{high}). Even if these problems and concerns with the prior art dual-bell nozzle 210 could be overcome, it remains unfeasible to use a large dual-bell nozzle 210 as a propulsive landing system for an upper stage rocket. Large nozzles are difficult to protect during reentry because they are very thin and incur severe flow separation and side loads in the atmosphere.

Aspects of the present invention are directed to these and other problems.

### SUMMARY

According to an aspect of the present invention, a nozzle includes a throat, a first expansion section extending downstream of the throat, and a second expansion section extending downstream of the first expansion section. An inflection point is defined where the first expansion section meets the second expansion section. The first expansion section has a first contour designed for optimal performance throughout a first altitude range. The second expansion section has a second contour designed for optimal performance throughout a second altitude range. The first altitude range and the second altitude range are separated by a third altitude range.

According to another aspect of the present invention, an engine includes a high-pressure chamber and a nozzle that exhausts gas emitted by the high-pressure chamber. The nozzle includes a throat, a first expansion section extending downstream of the throat, and a second expansion section extending downstream of the first expansion section. An inflection point is defined where the first expansion section meets the second expansion section. The first expansion section has a first contour designed for optimal performance throughout a first altitude range. The second expansion section has a second contour designed for optimal performance throughout a second altitude range. The first altitude range and the second altitude range are separated by a third altitude range.

According to another aspect of the present invention, a heat shield for protecting a windward side of a vehicle from a high enthalpy flow includes a wall defining at least a first portion of an outer heat shield surface on the windward side of the vehicle during exposure to the high enthalpy flow. The wall includes an opening that defines an exit of a dual-expansion nozzle.

According to another aspect of the present invention, a vehicle includes a heat shield wall and a dual-expansion nozzle. The heat shield wall defines at least a portion of an outer heat shield surface on the windward side of the vehicle during exposure to a high enthalpy flow. The dual-expansion nozzle is recessed into the heat shield wall.

According to another aspect of the present invention, a vehicle includes a heat shield and a plurality of thrusters. The heat shield defines a windward side of the vehicle exposed to a high enthalpy flow. The thrusters are recessed into the heat shield. Each thruster includes a high-pressure chamber that emits a gas for thrust and a dual-expansion nozzle that exhausts the gas emitted by the high-pressure chamber.

In addition to, or as an alternative to, one or more of the features described above, further aspects of the present invention can include one or more of the following features, individually or in combination:
the throat, the first expansion section, and the second expansion section are components of a dual-expansion nozzle portion of the nozzle, and the nozzle further includes a secondary nozzle portion downstream of the dual-expansion nozzle portion;
the secondary nozzle portion is formed by a centerbody;
the first altitude range extends between sea level and a first threshold altitude, and the first threshold altitude is in a range from 0.1 km to 4 km from sea level;
the second altitude range extends between a second threshold altitude and a maximum mission altitude, and the second threshold altitude is in a range from 60 km to 100 km from sea level;
the third altitude range spans a distance of at least 56 km;
the throat, the first expansion section, and the second expansion section extend annularly about an axis, the first expansion section is axisymmetric relative to the axis, and the second expansion section is non-axisymmetric relative to the axis;
the throat, the first expansion section, and the second expansion section extend annularly about an axis, the first expansion section is non-axisymmetric relative to the axis, and the second expansion section is non-axisymmetric relative to the axis;
respective exit planes of the first expansion section and the second expansion section are not parallel relative to one another;
the throat, the first expansion section, and the second expansion section extend annularly about an axis, and the second expansion section includes an upstream portion that is axisymmetric relative to the axis, and a downstream extension portion that is non-axisymmetric relative to the axis;
the wall is a thruster mount wall, and the heat shield further includes a centerbody wall defining a second portion of the outer heat shield surface;
the thruster mount wall extends annularly about the centerbody wall;
the thruster mount wall and centerbody wall are at least substantially flush relative to one another;
the thruster mount wall and the centerbody wall form a blunt body;
the opening is a first opening among a plurality of thruster openings in the wall, the dual-expansion nozzle is a first dual-expansion nozzle among a plurality of dual-expansion nozzles, and each thruster opening in the wall defines an exit of one of the dual-expansion nozzles;
the wall is a thruster mount wall, the heat shield further includes a centerbody wall defining a second portion of the outer heat shield surface, the thruster mount wall extends annularly about the centerbody wall, and the thruster openings are circumferentially spaced around the thruster mount wall;
the thruster mount wall further includes a plurality of bleed openings through which an exhaust fluid exits the heat shield, the bleed openings are circumferentially spaced around the thruster mount wall, and the bleed openings are positioned relative to the thruster openings such that the exhaust fluid exiting each bleed opening influences an exhaust plume exiting a nearby thruster opening;
each bleed opening is at a circumferential position between two circumferentially-adjacent thruster openings;
the bleed openings are radially inward of the thruster openings;
the wall further includes a bleed opening through which an exhaust fluid exits the heat shield;
the exhaust fluid is a turbine exhaust fluid;
the bleed opening is configured such that the exhaust fluid exiting therethrough influences an exhaust plume exiting the opening that defines the exit of the dual-expansion nozzle;
the exit of the dual-expansion nozzle is at least substantially flush with the heat shield outer surface;
the heat shield is actively-cooled during exposure to the high enthalpy flow;
an opening in the heat shield wall defines an exit of the dual-expansion nozzle;
an exit of the dual-expansion nozzle is at least substantially flush with the outer heat shield surface;
the vehicle is a reusable upper stage rocket, and the high enthalpy flow is an atmospheric reentry flow;
the dual-expansion nozzle is a dual-bell nozzle;
a centerline of the heat shield is not offset relative to a centerline of a main body of the vehicle;
a centerline of the heat shield is offset relative to a centerline of a main body of the vehicle;
each thruster extends along a respective thruster axis, and each thruster is oriented such that the thruster axis thereof is parallel relative to the centerline of the main body of the vehicle;
each thruster is positioned at a different axial position along the vehicle; and
the plurality of thrusters include at least a first thruster and a second thruster, a first distance extends between the first thruster and a forward end of the vehicle in a direction of a centerline of a main body of the vehicle, a second distance extends between the second thruster and the forward end of the vehicle in the direction of the centerline of the main body, and the first distance is different than the second distance.

These and other aspects of the present invention will become apparent in light of the drawings and detailed description provided below.

### BRIEF DESCRIPTION OF THE DRAWINGS

FIG. 1 schematically illustrates a prior art dual-bell nozzle engine.

FIGS. 2 and 3 schematically illustrate the prior art dual-bell nozzle engine of FIG. 1 during operation in a low altitude range (FIG. 2) and a high altitude range (FIG. 3).

FIG. 4 schematically illustrate the flight trajectory of a two-stage rocket system with a lower stage rocket powered by the prior art dual-bell nozzle engine of FIG. 1.

FIG. 5 is an elevation view of a two-stage rocket system including an upper stage rocket with the present nozzle.

FIG. 6 is an exploded elevation view of the two-stage rocket system of FIG. 5.

FIG. 7 is a perspective view of the upper stage rocket of FIG. 5.

FIG. 8 is an elevation view of the upper stage rocket of FIG. 5 in a zero angle of attack orientation.

FIG. 9 is an elevation view of the upper stage rocket of FIG. 5 in a non-zero angle of attack orientation.

FIG. 10 is an elevation view of the aft end of the upper stage rocket of FIG. 5.

FIG. 11 schematically illustrates a portion of the engine and nozzle of the upper stage rocket of FIG. 5.

FIGS. 12 and 13 schematically illustrate the thrusters of FIG. 11 during operation in a low altitude range (FIG. 12) and a high altitude range (FIG. 13).

FIG. 14 schematically illustrates the relative axial positions of the thrusters on the upper stage rocket of FIG. 5.

FIG. 15 is a plan view of the aft end of the upper stage rocket of FIG. 5.

FIG. 16 is an enlarged portion of the plan view in FIG. 15.

FIG. 17 schematically illustrates the flight trajectory of the two-stage rocket system of FIG. 5.

### DETAILED DESCRIPTION

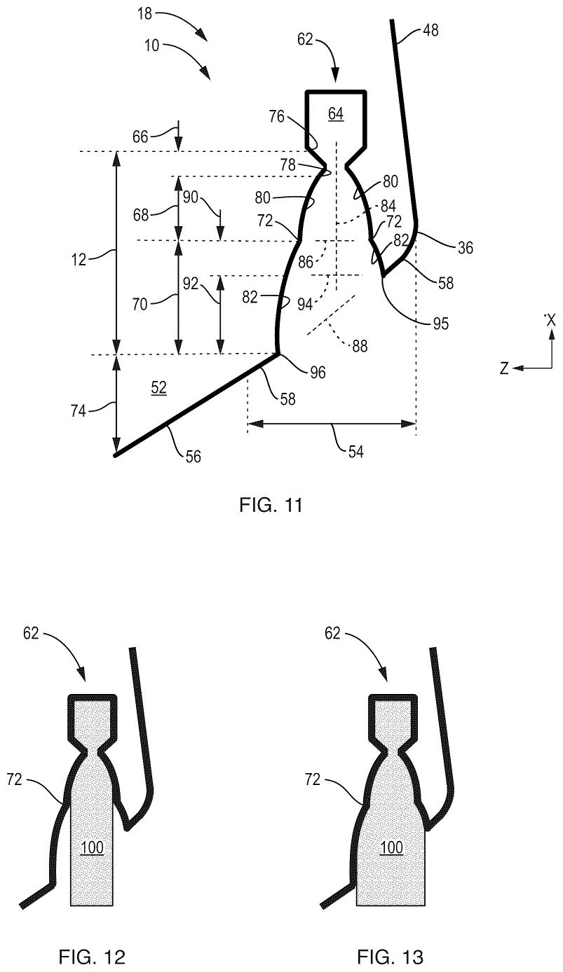

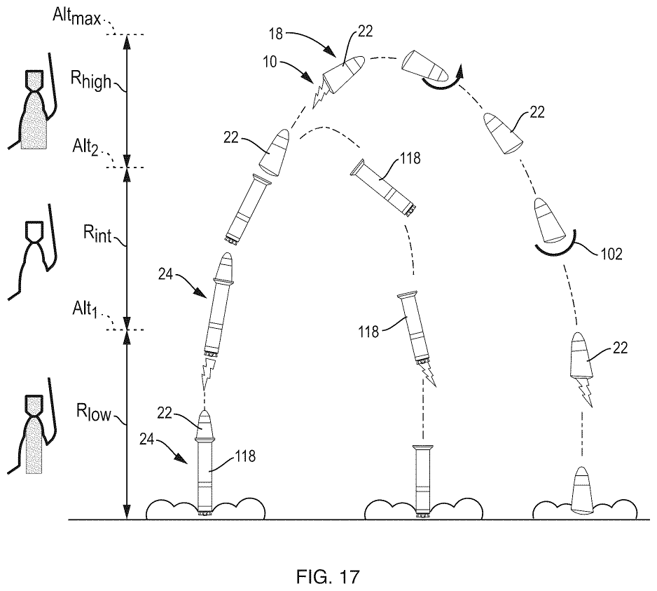

Referring to FIGS. 6-9 and 11, the present disclosure describes a nozzle 10 with an initial nozzle portion 12 (see FIG. 11) in the form of a so-called “dual-expansion” or “dual-bell” nozzle. The initial nozzle portion 12, which is referred to hereinafter as a “dual-expansion nozzle portion 12” or just a “dual-expansion nozzle 12,” is optimized for performance within two (2) discrete and non-contiguous altitude ranges R_{low}, R_{high} (see FIG. 17). The present disclosure further describes an engine 18 including the nozzle 10, a heat shield 20 into which at least portions of the nozzle 10 are recessed, and a vehicle 22 including the nozzle 10.

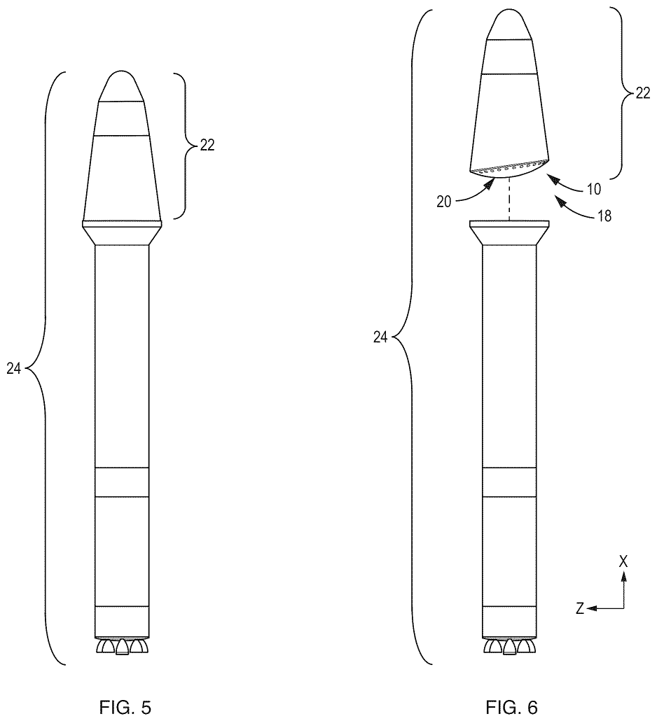

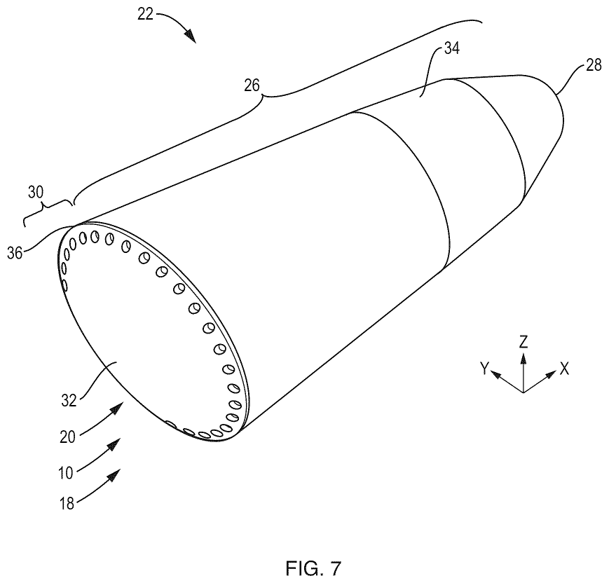

The vehicle 22 is a rocket (e.g., a multi-stage rocket, a single-stage-to-orbit (SSTO) rocket, an upper stage rocket, a booster rocket, etc.), a missile, a spacecraft, an aircraft, or another vehicle designed for travel (e.g., flight) up to at least supersonic speeds (e.g., supersonic speeds, hypersonic speeds, reentry speeds, etc.) in atmospheric, sub-orbital, orbital, extraterrestrial, and/or outer space environments. Referring to FIGS. 5-6, in the illustrated embodiment, the vehicle 22 is a reusable second stage rocket of a two-stage rocket system 24. Referring to FIG. 7, the vehicle 22 includes a main body 26 defining a forward end 28 of the vehicle 22, and a base 30 defining an aft end 32 of the vehicle 22. The main body 26 includes a payload housing 34, and the base 30 includes the heat shield 20 into which at least portions of the nozzle 10 are recessed. The vehicle 22 includes a shoulder 36 defined where an outer surface of the main body 26 meets an outer surface of the base 30. The main body 26 defines the windward side of the vehicle 22 during liftoff and ascent, and the base 30 defines the windward side of the vehicle 22 during atmospheric reentry and landing, as will be described in more detail below.

In some embodiments, the vehicle 22 has a non-axisymmetric shape that allows the vehicle 22 to generate lift when oriented at a zero angle of attack during atmospheric reentry, in a same or similar manner as disclosed in the commonly-assigned U.S. Provisional Patent Application No. 63/174,323 filed Apr. 13, 2021, U.S. Provisional Patent Application No. 63/236,002 filed Aug. 23, 2021, International Patent Application No. PCT/US22/71686 filed Apr. 13, 2022, and International Patent Application No. PCT/US22/71688 filed Apr. 13, 2022, the contents of which are incorporated herein by reference in their entirety.

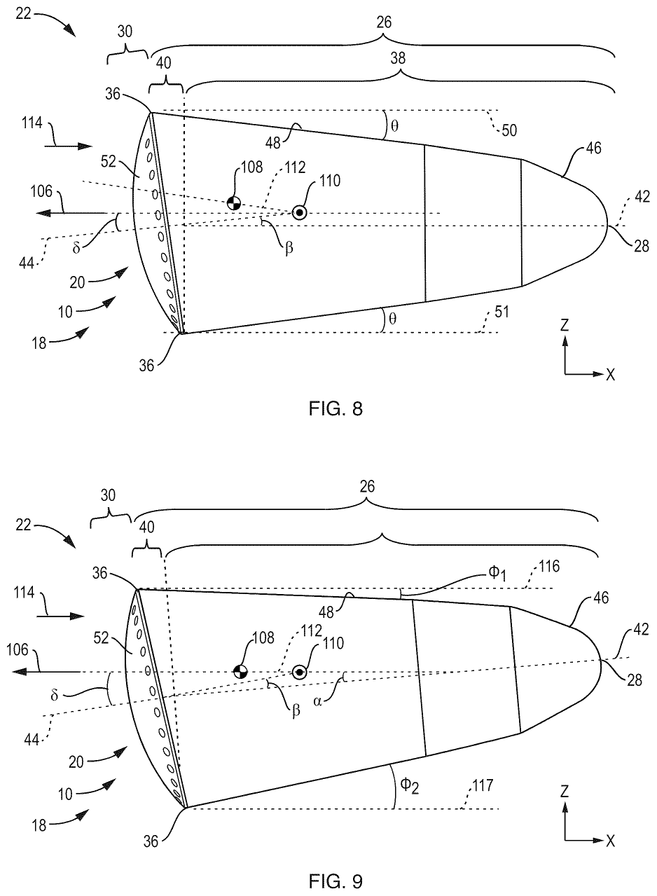

Referring to FIGS. 8 and 9, in the illustrated embodiment, the main body 26 includes an axisymmetric forward main body section 38 and a non-axisymmetric aft main body section 40. The forward main body section 38 is shaped such that the outer surface thereof is at least substantially axisymmetric relative to a main body centerline 42 (e.g., a linear centerline perpendicular to the tangent of the forwardmost point of the main body 26) extending in a direction between the forward end of the main body 26 and the opposing aft end of the main body 26. The aft main body section 40 is shaped such that the outer surface thereof is non-axisymmetric relative to the main body centerline 42. In the illustrated embodiment, the outer surface of the aft main body section 40 defines an oblique frustoconical shape.

Referring still to FIGS. 8 and 9, the base 30 of the vehicle 22 is shaped such that the outer surface thereof is at least substantially axisymmetric relative to a base centerline 44 (e.g., a linear centerline perpendicular to the tangent of the aftmost point of the base 30) extending in a direction between a forward end of the base 30 (e.g., proximate the shoulder 36) and the opposing aft end of the base 30. The vehicle 22 is therefore configured such that the base centerline 44 (also referred to herein as the “heat shield centerline 44”) is offset relative to the main body centerline 42 by an angle β. The angle β is typically within the range of 1° to 10°. In the illustrated embodiment, the angle β is 8°. In other embodiments, the angle β is approximately 1°, 2°, 3°, 4°, 5°, 6°, 7°, 9°, or 10°, for example. In other embodiments, the base centerline 44 is not offset relative to the main body centerline 42, and thus the angle β is 0°.

Referring still to FIGS. 8 and 9, in the illustrated embodiment, the main body 26 of the vehicle 22 includes a nose 46 and a sidewall 48 extending aft of the nose 46. Referring to FIG. 8, the sidewall 48 is disposed at an angle θ (hereinafter the “sidewall angle θ”) relative to planes 50, 51 parallel to the main body centerline 42. In the illustrated embodiment, the vehicle 22 is designed with a relatively shallow sidewall angle θ (i.e., the sidewall angle θ has a low magnitude) in comparison to prior art vehicles. The sidewall angle θ is within the range of 0° to 90°. In some embodiments, the sidewall angle θ is within the range of 5° to 15°. In the illustrated embodiment, for example, the sidewall angle θ is 7°. The magnitude of the sidewall angle θ is inversely related (e.g., has a nonlinear inverse relationship) to the volume of the vehicle 22, and thus the shallow sidewall angle θ advantageously allows the vehicle 22, and in particular the payload housing 34, to have a larger volume than that of prior art vehicles.

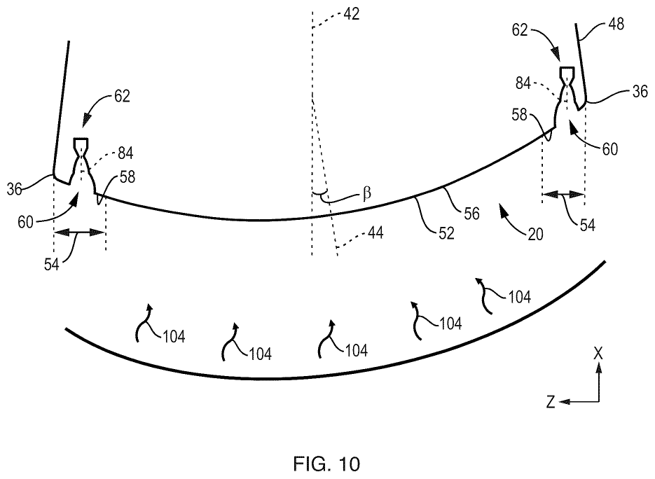

Referring to FIG. 10, the base 30 of the vehicle 22 includes one or more components that define the heat shield 20 and the outer surface thereof (i.e., the “heat shield outer surface”). In the illustrated embodiment, the base 30 includes a centerbody 52 and a thruster mount 54, which each define portions of the heat shield 20 and the heat shield outer surface, and which collectively form a blunt body. In some embodiments, the components that form the heat shield outer surface are metallic (e.g., formed of sheet metal), and the heat shield 20 may therefore be referred to as a metallic heat shield having a metallic heat shield outer surface.

Referring still to FIG. 10, the illustrated embodiment, the centerbody 52 includes a centerbody wall 56 with a semi-spherical shape that is axisymmetric relative to the base centerline 44. In other embodiments, the centerbody 52 additionally or alternatively includes one or more walls having a frustoconical shape, a multi-conic shape (e.g., bi-conic, tri-conic, etc.), a domed shaped, an ellipsoidal shape, and/or another blunt shape. In some embodiments, the centerbody wall 56 defines a shape that is non-axisymmetric relative to the base centerline 44. In some embodiments, the centerbody wall 56 and/or another component of the base 30 and/or the heat shield 20 is a curved thin wall formed from welded sheet metal components using techniques that are the same or similar to those described in U.S. Provisional Patent Application No. 63/363,867 filed Apr. 29, 2022, U.S. Provisional Patent Application No. 63/367,004 filed Jun. 24, 2022, U.S. Provisional Patent Application No. 63/384,175 filed Nov. 17, 2022, and International Patent Application No. PCT/US23/20269 filed Apr. 27, 2023, the contents of which are incorporated herein by reference in their entirety.

Referring still to FIG. 10, in the illustrated embodiment, the thruster mount 54 extends radially between the centerbody 52 and the shoulder 36 of the vehicle 22. The thruster mount 54 includes an annular thruster mount wall 58 with a plurality of openings 60 extending therethrough. Each opening 60 in the thruster mount wall 58 defines an exit of a thruster 62, which will be described in more detail below. In the illustrated embodiment, the shape of the thruster mount wall 58 corresponds to the shape of the centerbody wall 56, such that the thruster mount wall 58 and the centerbody wall 56 are at least substantially flush relative to one another and collectively form a continuous semi-spherical shape that is axisymmetric relative to the base centerline 44. In other embodiments, the thruster mount wall 58 and the centerbody wall 56 collectively form a frustoconical shape, a multi-conic shape, an ellipsoidal shape, a domed shaped, and/or another blunt shape. In other embodiments, the thruster mount wall 58 and the centerbody wall 56 collectively form a shape that is non-axisymmetric relative to the base centerline 44. In other embodiments, the thruster mount wall 58 and the centerbody wall 56 are not flush relative to one another and instead define an inflection point therebetween, in a same or similar manner as disclosed in the commonly-assigned U.S. Provisional Patent Application No. 63/174,323 filed Apr. 13, 2021, U.S. Provisional Patent Application No. 63/236,002 filed Aug. 23, 2021, International Patent Application No. PCT/US22/71686 filed Apr. 13, 2022, and International Patent Application No. PCT/US22/71688 filed Apr. 13, 2022, the contents of which are incorporated herein by reference in their entirety. Although the thruster mount wall 58 and the centerbody wall 56 are described as being discrete components, in some embodiments the thruster mount wall 58 and the centerbody wall 56, or one or more components thereof, are formed by a single component (e.g., a single wall component).

In the illustrated embodiment, the heat shield 20 is actively cooled using a heat shielding system that is the same or similar to the one disclosed in the commonly-assigned U.S. Provisional Patent Application No. 62,941,386, filed Nov. 27, 2019, U.S. Provisional Patent Application No. 62/942,886, filed Dec. 3, 2019, International Patent Application No. PCT/US2020/048178 filed Aug. 27, 2020, and International Patent Application No. PCT/US2020/48226 filed Aug. 27, 2020 filed Aug. 27, 2020, the contents of which are hereby incorporated by reference in their entirety. In some embodiments, at least a portion of the sidewall 48 of the main body 26 of the vehicle 22, and/or another component of the vehicle 22, is actively cooled in a same or similar manner.

In the illustrated embodiment, the heat shield 20 is part of a heat shield system that also includes a heat exchanger (not shown). The heat exchanger includes conduits disposed relative to the thruster mount wall 58 (FIG. 11) and the centerbody wall 56 (FIG. 11), which collectively define the heat shield outer surface. During atmospheric reentry, the heat shield system causes coolant to flow through the conduits of the heat exchanger to actively cool the heat shield 20 (e.g., the thruster mount wall 58 and the centerbody wall 56). The heat exchanger transfers an amount of energy from the heat shield 20 to the coolant to generate a heated fluid that can be used to drive a pump onboard the vehicle 22. In some embodiments, the amount of energy transferred to the coolant by the heat exchanger is enough to drive the pump. In some embodiments, at least one component of the heat shield system is an already-existing component of the engine (e.g., a tank, a pump, a turbine, etc.). In some embodiments, there will be an excess of energy in the heated coolant which will be used to pressurize or power an auxiliary system (e.g., a tank, a gas thruster, a transpiration cooling system, an auxiliary power unit (APU), etc.).

Referring to FIG. 11, the engine 18 includes at least one high-pressure chamber 64 (e.g., a combustion chamber) and at least one nozzle 10.

The high-pressure chamber 64 emits a gas that is exhausted through the nozzle 10. The high-pressure chamber 64 is in the form of an annular ring, a segmented ring, individual chambers, or another configuration providing supersonic flow to the nozzle 10.

Referring still to FIG. 11, the nozzle 10 includes at least one dual-expansion nozzle portion 12 through which exhaust gas initially exits the high-pressure chamber 64. Each dual-expansion nozzle portion 12 includes a throat 66, a first expansion section 68 downstream of the throat 66, a second expansion section 70 downstream of the first expansion section 68, and an inflection point 72 defined where the first expansion section 68 meets the second expansion section 70.

In some embodiments, the nozzle 10 includes at least one secondary nozzle portion 74 downstream of the dual-expansion nozzle portion 12. In some such embodiments, the nozzle 10 is a plug nozzle (e.g., an aerospike nozzle) and includes a secondary nozzle portion 74 defined by the centerbody 52. In some embodiments, the centerbody 52 is a plug with a plug length that is at or near zero percent (0%). In other embodiments, the centerbody 52 is a plug with a plug length that is less than or equal to 1%, 2%, 3%, 4%, 5%, 6%, 7%, 8%, 9%, or 10%, for example.

The engine 18 and the nozzle 10 can be configured in various different ways. In the illustrated embodiment, the engine 18 has a so-called “plug cluster” configuration. That is, the engine 18 includes a plurality of discrete high-pressure chambers 64 spaced relative to one another and a plurality of discrete dual-expansion nozzle portions 12 spaced relative to one another. In other embodiments not shown in the drawings, the engine 18 includes a single high-pressure chamber that extends annularly about the base centerline 44 and/or the main body centerline 42, and/or the nozzle 10 includes a single dual-expansion nozzle portion 12 that extends annularly about the base centerline 44 and/or the main body centerline 42, for example.

In the “plug cluster” configuration of the illustrated embodiment, each dual-expansion nozzle portion 12 is located relative to a corresponding high-pressure chamber 64 and is configured to exhaust gas exiting the respective high-pressure chamber 64. Each high-pressure chamber 64 and dual-expansion nozzle portion 12 pair is referred to herein as a “thruster 62.” In the illustrated embodiment, the thrusters 62 are selectively controllable for maintaining and/or changing an orientation of the vehicle 22 (e.g., during ascent and/or controlled landing).

Referring to FIG. 11, in the illustrated embodiment, the dual-expansion nozzle portion 12 of each thruster 62 includes a throat 66 that defines a transition between an upstream converging section with an annular converging surface 76 and a downstream diverging section with an annular diverging surface 78. The first expansion section 68 of the dual-expansion nozzle portion 12 extends downstream of the throat 66 and includes a first expansion surface 80 that is contiguous with (e.g., at least substantially flush with) the diverging surface 78 of the throat 66. The second expansion section 70 extends downstream of the first expansion section 68 and includes a second expansion surface 82 that meets the first expansion surface 80 at the annular inflection point 72.

In the illustrated embodiment, the throat 66 and the first and second expansion sections 68, 70 extend annularly about an axis 84 of the respective thruster 62 (hereinafter the “thruster axis 84”). The first expansion section 68 is axisymmetric relative to the thruster axis 84, and the exit 86 of the first expansion section 68 (e.g., the plane defined at the inflection point 72) is at least substantially perpendicular to the thruster axis 84. In contrast, the second expansion section 70 is non-axisymmetric relative to the thruster axis 84, and the exit 88 of the second expansion section 70 is not perpendicular to the thruster axis 84. The respective exit planes 86, 88 of the first and second expansion sections 68, 70 are oriented at different angles relative to the thruster axis 84 and are not parallel relative to one another.

Referring still to FIG. 11, in the illustrated embodiment, the second expansion section 70 includes an upstream portion. The upstream portion 90 of the second expansion section 70 defines an exit 94 that is perpendicular to the thruster axis 84 and intersects the radially outer aft end 95 of the second expansion surface 82. The extension portion 92 of the second expansion section 70 defines an exit 88 that is not perpendicular to the thruster axis 84. The exit 88 of the extension portion 92 extends between the radially outer aft end 95 and the radially inner aft end 96 of the second expansion surface 82. The exit 88 of the extension portion 92 corresponds to the exit of the dual-expansion nozzle portion 12 and the thruster 62 as a whole. In the illustrated embodiment, the thrusters 62 are recessed into the heat shield outer surface such that the exit 88 of each thruster 62 is at least substantially flush with the heat shield outer surface. In particular, the thrusters 62 are recessed into the thruster mount wall 58 such that the exit 88 of each thruster 62 is at least substantially flush with the outer surface of the thruster mount wall 58. In other embodiments not shown in the drawings, both the upstream portion 90 and the downstream extension portion 92 of the second expansion section 70 are non-axisymmetric relative to the thruster axis 84.

Referring to FIGS. 11-13 and 17, the contour of the first expansion section 68 is designed such that the first expansion section 68 performs optimally (e.g., provides a constant momentum thrust) throughout a first altitude range R_{low} (see FIG. 17), and the contour of the second expansion section 70 is designed such that the second expansion section 70 performs optimally throughout a second altitude range R_{high} (see FIG. 17), as will be described in more detail below. The specific contour designs will depend on the particular application, and can be selected and/or optimized using methods by Angelino (see G. Angelino, Approximate Method for Plug Nozzle Design, AIAA Journal, Vol. 2, Issue 10, pp. 1834-1835 (1964)), Rao (see G. V. R. Rao, Exhaust Nozzle Contour for Optimum Thrust, Journal of Jet Propulsion, Vol. 28, No. 6, pp. 377-382 (1958)), and/or other methods known in the art.

Referring back to FIG. 10, in the illustrated embodiment, each thruster 62 is configured such that the thruster axis 84 thereof is at least substantially parallel to the main body centerline 42. In the illustrated embodiment, this is true despite the fact that the thrusters 62 are recessed into a heat shield outer surface that is skewed relative to the main body centerline 42 by the angle β, as discussed above. In other embodiments not shown in the drawings, one or more of the thrusters 62 are configured such that their respective axes 84 are skewed (e.g., not parallel) relative to the main body centerline 42.

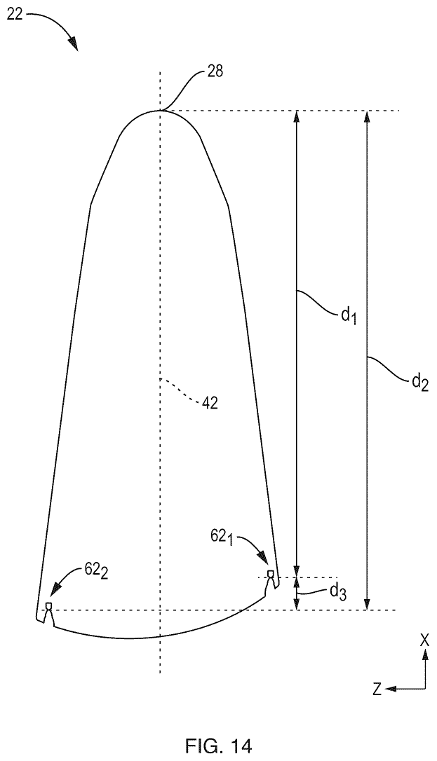

In some embodiments, the thrusters 62 are positioned at different axial positions on the vehicle 22. Referring to FIG. 14, in some embodiments, the axial distance d₁ from a first thruster 62₁ (e.g., from the throat of the thruster 62₁) to the forward end 28 in the direction of the main body centerline 42 has a first magnitude, and the axial distance d₂ from a second thruster 62₂ (e.g., from the throat of the thruster 62₂) to the vehicle nose 46 in the direction of the main body centerline 42 has a second magnitude that differs from the first magnitude. In such embodiments, the first and second thrusters 62₁, 62₂ are axially spaced relative to one another by an axial distance d₃ in the direction of the main body centerline 42. In the illustrated embodiment, in which the vehicle 22 includes thirty (30) circumferentially-spaced thrusters 62 recessed into a heat shield outer surface that is skewed relative to the main body centerline 42 by the angle β, the axial position of each thruster 62 is slightly different from each circumferentially-adjacent thruster 62. In other embodiments, such as those in which the heat shield outer surface is not skewed relative to the main body centerline 42, all of the thrusters 62 are at a same axial position on the vehicle 22 (i.e., the axial distance d₃ is zero (0)).

Referring back to FIG. 11, in the illustrated embodiment, the thrusters 62 are at least substantially identical to one another, except the downstream extension portion 92 of the second expansion section 70 differs from one thruster 62 to the next. In the illustrated embodiment, the high-pressure chamber 64, the throat 66, the first expansion section 68, and the upstream portion 90 of the second expansion section 70 are identical for each of the thirty (30) thrusters 62. In other embodiments, the thrusters 62 can be entirely identical.

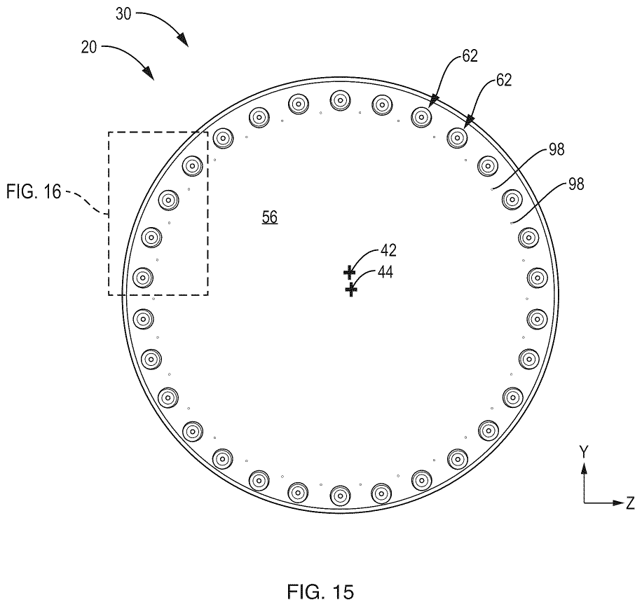

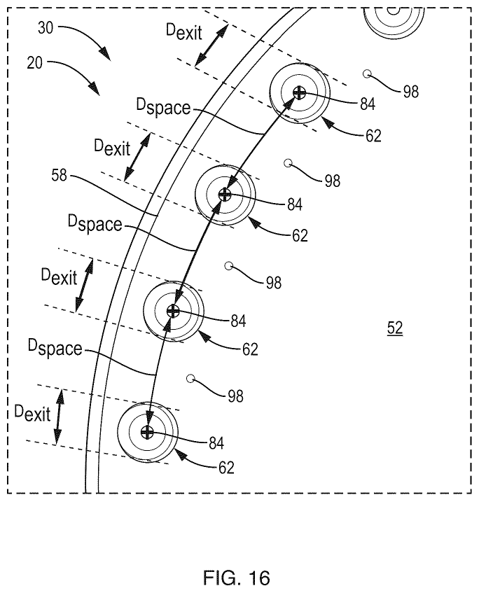

Referring to FIGS. 15 and 16, in some embodiments, the thrusters 62 are circumferentially spaced relative to the main body centerline 42 such that each discrete thruster 62 is separated from a circumferentially-adjacent thruster 62 in a same or similar manner as disclosed in the commonly-assigned U.S. Provisional Patent Application No. 63/174,323 filed Apr. 13, 2021, U.S. Provisional Patent Application No. 63/236,002 filed Aug. 23, 2021, International Patent Application No. PCT/US22/71686 filed Apr. 13, 2022, and International Patent Application No. PCT/US22/71688 filed Apr. 13, 2022, the contents of which are incorporated herein by reference in their entirety. That is, each discrete thruster 62 is separated from a circumferentially-adjacent thruster 62 by a spacing distance D_{space} that is greater than or equal to the product of an exit dimension Dₑₓᵢₜ of the thruster 62 and a multiplication factor M having a magnitude greater than or equal to one (1). In the illustrated embodiment, the exit dimension Dₑₓᵢₜ is measured at the exit 94 of the upstream portion 90 of the second expansion section 70 (see FIG. 11). In other embodiments, the exit dimension Dₑₓᵢₜ can be measured at a different position, such as the exit 88 of the thruster 62 as a whole.

Referring to FIG. 16, in the illustrated embodiment, the spacing distance D_{space} is an arc length extending between the axis 84 of a first thruster 62 and the axis 84 of a circumferentially-adjacent thruster 62. In other embodiments, the spacing distance D_{space} is a chord length between the axis 84 of a first thruster 62 and the axis 84 of a circumferentially-adjacent thruster 62.

Referring still to FIG. 16, in the illustrated embodiment, the multiplication factor M is approximately two (2) and the thrusters 62 are spaced uniformly around the centerbody 52 such that the spacing distance D_{space} between a pair of circumferentially-adjacent thrusters 62 has a same magnitude as the respective spacing distances D_{space} between every other pair of circumferentially-adjacent thrusters 62. In other embodiments, the thrusters 62 are spaced non-uniformly around the centerbody 52 such that the spacing distance D_{space} between a pair of circumferentially-adjacent thrusters 62 has a different magnitude from the spacing distance D_{space} between at least one other pair of circumferentially-adjacent thrusters 62.

The magnitude of the multiplication factor M can vary based on one or more cost and/or performance factors, including, for example: a dimension and/or geometry of the engine 18, the nozzle 10, the vehicle 22, and/or a component thereof (e.g., a diameter of the vehicle 22, an exit dimension Dₑₓᵢₜ of the thruster 62, a desired nozzle expansion ratio, etc.); the total number of thrusters 62 included in the engine 18; a mass of the engine 18, the nozzle 10, the vehicle 22, and/or a component thereof; and/or a desired performance characteristic (e.g., thrust-to-weight ratio, thrust coefficient C_{F}, specific impulse Iₛₚ, characteristic velocity c*, etc.).

Applicant continues to achieve unexpected results (e.g., improved thrust performance, minimized efficiency loss, etc.) when widely spacing thrusters 62 relative to one another such that D_{space}>M*Dₑₓᵢₜ, where M is greater than or equal to one (1). For example, Applicant achieved unexpected results in connection with the illustrated embodiment, in which the thrusters 62 are spaced relative to one another such that D_{space}=M*Dₑₓᵢₜ, where M is approximately two (2). Applicant discovered that when the number of thrusters 62, the spacing distance D_{space}, between the thrusters 62, and the exit dimension Dₑₓᵢₜ of the thrusters 62 are selected as design variables, the thrust coefficient C_{F} can be optimized by widely spacing thrusters 62 relative to one another such that D_{space}≥M*Dₑₓᵢₜ, where M is greater than or equal to one (1). The thrust T of the engine 18 can be defined as

$$T ≡ ( \dot{m} ) ( {c}^{*} ) ( {C}_{F} )$$

where \dot{m} is the mass flow rate of propellant, c* is the characteristic velocity of the combustion gasses in the chamber 64 and is a measure of the energy generated by combustion, and C_{F} is the nozzle thrust coefficient. The thrust coefficient determines the amplification of thrust due to gas expansion in the nozzle 10, and can be defined in terms of nozzle parameters using the equation

$${C}_{F} ≡ {η}_{{C}_{F}} [ \sqrt{( \frac{2 {γ}^{2}}{γ - 1} ) {( \frac{2}{γ + 1} )}^{\frac{γ + 1}{γ - 1}} ( 1 - {( \frac{{P}_{e}}{{P}_{o}} )}^{\frac{γ - 1}{γ}} )} + ( \frac{{P}_{e}}{{P}_{o}} - \frac{{P}_{a}}{{P}_{o}} ) \frac{{A}_{e}}{{A}_{t}} ]$$

where η_{CF} is the thrust coefficient efficiency, γ is the ratio of specific heats of the combustion gas, Pₒ is the total stagnation pressure in the chamber 64, Pₑ is the static pressure at the exit of the nozzle, Pₐ is the ambient static pressure in the surrounding environment, and Aₑ/Aₜ is the area ratio between the nozzle exit and the throat. Widely spacing thrusters 62 relative to one another can trade a reduction in efficiency η_{CF} in exchange for a more significant increase in area ratio Aₑ/Aₜ, resulting in an overall more optimal solution.

Referring to FIGS. 15 and 16, in some embodiments, the thruster mount wall 58 (see FIG. 11) and/or the centerbody wall 56 (see FIG. 11) of the base 30 include one or more base bleed openings 98 through which turbine exhaust exits the vehicle 22. In the illustrated embodiment, the base 30 includes thirty (30) circumferentially-spaced openings 98 in the thruster mount wall 58. The openings 98 are radially inward relative to the thrusters 62 and are oriented such that each opening 98 is at a circumferential position between two circumferentially-adjacent thrusters 62. The circumferential distance between each opening 98 and a nearest thruster 62 is equal to approximately one-half of the spacing distance D_{space}. The number of openings 98, the size of the openings 98, and/or the positions of the openings 98 can vary depending on the particular application. In some embodiments, the openings 98 are configured such that the turbine exhaust exiting therethrough influence the respective plumes 100 (FIGS. 12 and 13) exiting one or more nearby thrusters 62. In some embodiments, the openings 98 are configured such that the turbine exhaust exiting therethrough causes plumes 100 of the thrusters 62 to merge with one another at a position further downstream of the base 30 than where the plumes 100 would otherwise merge.

In some embodiments, the thrusters 62 and the centerbody 52 are configured such that exhaust plumes 100 (FIGS. 12 and 13) from the various thrusters 62 merge to form an aerodynamic spike which traps a positive pressure along the centerbody 52. This generates additional thrust and improves the overall efficiency of the nozzle 10 and the engine 18. In some embodiments, the thrusters 62 are so widely spaced, and/or the centerbody 52 has such a short plug length, that the respective plumes of the thrusters 62 never merge as in a conventional aerospike, or only partially merge as in a conventional aerospike. In some embodiments in which the plumes 100 never merge or only partially merge, the plumes 100 still trap gas in a recirculation zone behind the centerbody 52 during nose-first travel of vehicle 22. The gas trapped in the recirculation zone can create an aerospike effect that generates additional thrust.

During operation, the vehicle 22 moves through an environment (e.g., the atmosphere, space) at freestream Mach numbers that can approach Mach thirty (30). Referring again to FIG. 10, during atmospheric reentry, a bow shock 102 is formed upstream of the vehicle 22, and the temperature on the vehicle side of the bow shock 102 can reach thousands of degrees Kelvin. The bow shock 102 generates significant drag to reduce the velocity of the vehicle 22, and also generates significant aerodynamic heating 104 on the heat shield 20, thereby necessitating cooling and/or other thermal protection for reusability, such as the above-mentioned active cooling system.

Referring again to FIG. 8, the vehicle 22 may initially re-enter the atmosphere at a so-called zero angle of attack (i.e., α=) 0°, in which the vehicle 22 is oriented such that the main body centerline 42 is parallel to the direction of travel 106. In this orientation, the heat shield centerline 44 is offset relative to the direction of travel 106 by an angle δ equal to the angle β at which the heat shield centerline 44 is offset relative to the main body centerline 42. In the zero angle of attack orientation, the center of gravity 108 and the center of pressure 110 of the vehicle 22 are in a plane 112 offset relative to the direction of travel 106. The fact that the heat shield outer surface is skewed relative to the main body centerline 42 by an angle β advantageously causes a net lift force on the vehicle 22 relative to the direction of travel 106, even at the zero angle of attack.

During operation of the vehicle 22 at a zero angle of attack (FIG. 8), the aerodynamic lift and drag forces on the vehicle 22 will generate pitching moments about the center of gravity 108, and the vehicle 22 will naturally adopt an orientation at which those moments are balanced (i.e., the aerodynamic trim point). This orientation, shown in FIG. 9, increases an angle α between the main body centerline 42 and the high enthalpy flow 114 that is moving relative to the vehicle 22 in a direction opposite the direction of travel 106. The non-zero angle of attack orientation (FIG. 9) therefore generates additional lift than the zero angle of attack orientation (FIG. 8). In the non-zero angle of attack (FIG. 9), the plane 112 of the center of gravity 108 and the center of pressure 110 will be parallel relative to the direction of travel 106, and opposing sides of the vehicle 22 will be at different respective angles φ₁, φ₂ relative to planes 116, 117 parallel to the direction of travel 106. The heat shield centerline 44 is offset relative to the direction of travel 106 by an angle δ equal to the sum of: (i) the angle α between the main body centerline 42 and the high enthalpy flow 114; and (ii) the angle β at which the heat shield centerline 44 is offset relative to the main body centerline 42. The angle of attack α should not exceed the sidewall angle θ. Thus, in the illustrated embodiment, the vehicle 22 should not be flown at an angle of attack α that exceeds 7°. Maintaining the angle of attack α below this threshold prevents the high enthalpy flow 114 from impinging on the sidewall 48 of the vehicle 22, eliminating the need for additional heat shielding (and the accompanying additional mass) on those surfaces the sidewall 48. The center of gravity 108 and the center of pressure 110 of the vehicle 22 can be selected to achieve a particular non-zero angle of attack during atmospheric reentry.

The skewed nature of the heat shield 20 (e.g., the oblique angle β of the heat shield outer surface relative to the main body centerline 42) allows the vehicle 22 to achieve a higher lift-to-drag ratio within a certain angle of attack constraint. That is, the vehicle 22 can achieve a certain target lift-to-drag ratio with a lower range of angles of attack α. This allows a shallower sidewall angle θ while still preventing hypersonic flow 114 from impinging on the sidewall 48 of the vehicle 22. This in turn allows for increased volume available for other system uses (e.g., propellant, payload, etc.).

To minimize the additional mass of the heat shield 20 and aerodynamic controls, the vehicle 22 exposes only the relatively small heat shield 20 of the vehicle 22 to the high enthalpy flow 114, while also generating a sufficient lift-to-drag ratio for precise maneuvering and landing. By adjusting both the angle β of the heat shield outer surface relative to the main body centerline 42, and the location of the center of gravity 108, the design of the vehicle 22 can be adjusted to produce different amounts of lift while maintaining the same trimmed angle of attack α. This adds freedom in the design space which is not available for traditional axisymmetric vehicle shapes. The combined surfaces of the heat shield 20 and nozzle 10 are advantageous in that they result in a lower mass penalty for the heat shield 20 in a reusable upper stage application.

Referring to FIG. 17, in embodiments in which the vehicle 22 is an upper stage of a two-stage rocket system 24, the vehicle 22 can be operated in several different modes across different phases of a flight trajectory. During liftoff and initial ascent phases, the upper stage rocket 22 is fixed to the forward end of a lower stage rocket 118 that propels the rocket system 24 through low and intermediate altitude ranges R_{low}, Rᵢₙₜ and towards a high threshold altitude Alt₂ defining a lower limit of a high altitude range R_{high}. During the liftoff and initial ascent phases, the engine 18 and nozzle 10 of the upper stage rocket 22 are not operational. When the rocket system 24 is at or near the high threshold altitude Alt₂, the upper stage rocket 22 separates from the lower stage rocket 118 and begins a final ascent phase during which the engine 18 and nozzle 10 are operated to propel the upper stage rocket 22 to a maximum mission altitude Altₘₐₓ. The upper stage rocket 22 then begins a base-first descent. During an initial descent phase, the upper stage rocket 22 descends through the high altitude range R_{high} and the intermediate altitude range Rᵢₙₜ until a low threshold altitude Alt₁ is reached. During the initial descent phase, operation of the engine 18 and nozzle 10 is paused, and the heat shield 20 is actively cooled to protect the upper stage rocket 22 from the harsh atmospheric reentry environment. Once the upper stage rocket 22 reaches the low threshold altitude Alt₁, a propulsive landing phase begins during which the engine 18 and nozzle 10 are operated within the low altitude range R_{low} to controllably land the upper stage rocket 22 at a precise location where it can be retrieved and prepped for reuse.

In some embodiments, the low threshold altitude Alt₁ is in the range from 0.1 km and 4 km from sea level, the high threshold altitude Alt₂ is in the range from 60 km and 100 km from sea level, and the maximum mission altitude Altₘₐₓ is above 100 km from sea level. The intermediate altitude range Rᵢₙₜ extending between the low and high altitude ranges R_{low}, R_{high} can therefore span a distance of 56 km to 99.9 km. The low threshold altitude Alt₁ can vary based on one or more factors, including the terminal velocity of the upper stage rocket 22 during the descent and/or a thrust level generated by the nozzle 10. The terminal velocity can vary based on various characteristics of the upper stage rocket 22, including the drag value of the upper stage rocket 22 and/or the mass of the upper stage rocket 22 during descent.

Referring to FIGS. 11 and 17, the contour of the second expansion section 70 is designed such that the second expansion section 70 performs optimally when the engine 18 and nozzle 10 are operated within the high altitude range R_{high} during the final ascent phase, and the contour of the first expansion section 68 is designed such that the first expansion section 68 performs optimally when the engine 18 and nozzle 10 are operated within the low altitude range R_{low} during the controllable landing phase. During the final ascent phase, the engine 18 and nozzle 10 operate in a low pressure mode (or high altitude mode) in which the plume 100 is attached to the second expansion section 70 as shown in FIG. 13. During the controllable landing phase, the engine 18 and nozzle 10 operate in a high-pressure mode (or low altitude mode) in which the plume 100 separates from the nozzle wall at the inflection point 72 as shown in FIG. 12.

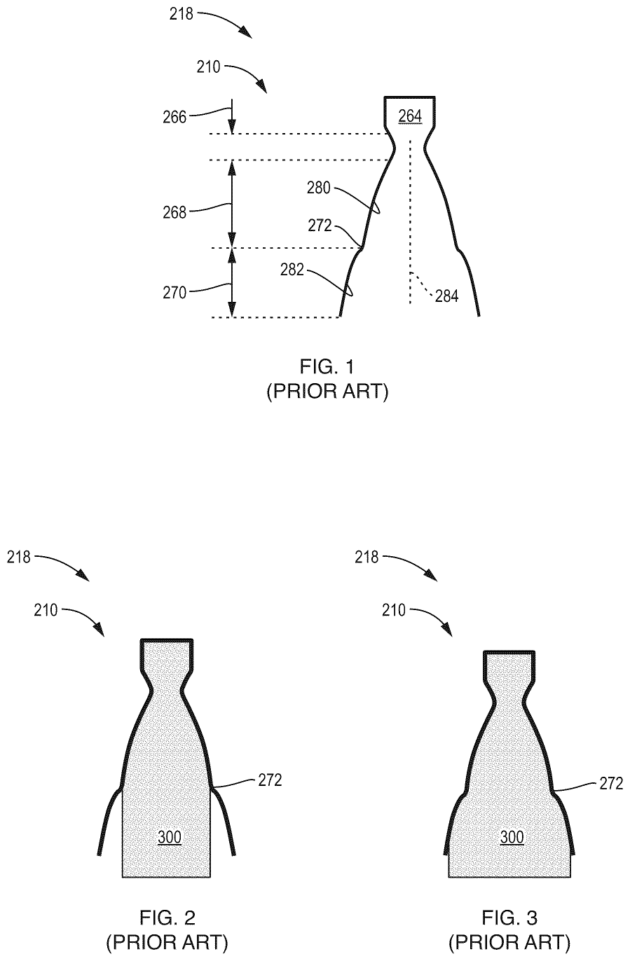

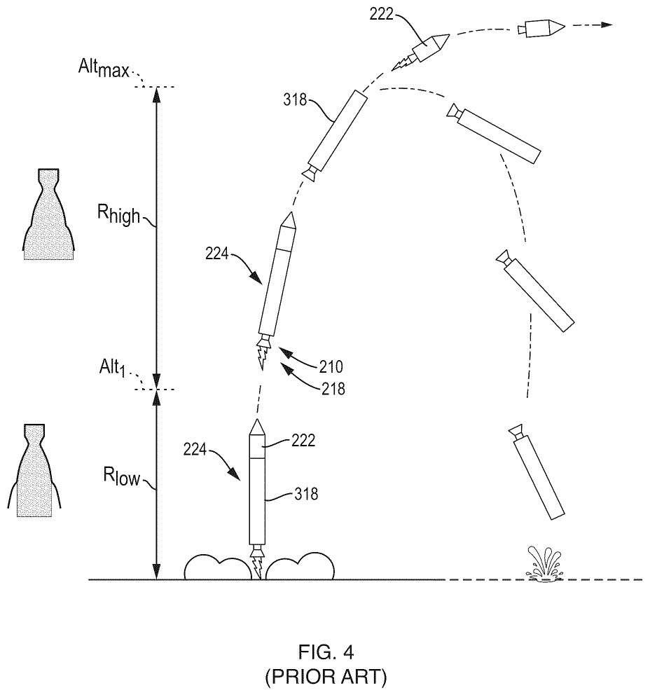

In summary, the engine 18 and nozzle 10 are operated in a low pressure mode (e.g., during the final ascent phase and on-orbit operations within the high altitude range R_{high}), then the operation of the engine 18 and nozzle 10 is paused (e.g., during the initial descent phase through the intermediate altitude range Rᵢₙₜ), and finally the engine 18 and nozzle 10 are operated in a high-pressure mode (e.g., during the controlled landing phase in the low altitude range R_{low}). This operate-pause-operate sequence allows the present nozzle 10 to avoid problems that arise with prior art dual-bell nozzles. In the prior art dual-bell nozzle 210 of FIG. 1, for example, the first and second expansions sections 268, 270 are optimized for performance within low and high altitude ranges R_{low}, R_{high} that are contiguous with one another. That is, the low and high altitude ranges R_{low}, R_{high} form one continuous altitude range; they are not separated by an intermediate altitude range Rᵢₙₜ as in FIG. 17. In order to achieve an immediate and smooth transition at the transition altitude Alt₁ between the low and high altitude ranges R_{low}, R_{high} (see FIG. 1), the prior art dual-bell nozzle 210 required an inflection point 272 with a precisely manufactured shape and position (e.g., a sharp angle) that resulted in reduced performance within each range individually. The present nozzle 10 eliminates all concerns with achieving a smooth transition at a predetermined transition altitude due to the operate-pause-operate sequence described above. As such, the present nozzle 10 has higher performance than the prior art dual-bell nozzle 210. The inflection point 72 of the present nozzle 10 can be a shallower angle that is implemented with less precision. Moreover, the present nozzle 10 can be designed for optimal use within altitude ranges that are much smaller than the altitude ranges R_{low}, R_{high} of the prior art dual-bell nozzle 210. As such, the present nozzle 10 can achieve higher efficiencies than the prior art dual-bell nozzle 210 in the low and high altitude ranges R_{low}, R_{high} in which it operates, and can even achieve higher efficiencies than a conventional single-bell nozzle (which is designed for optimal use within a larger altitude range) in the low altitude range R_{low}.

While several embodiments have been disclosed, it will be apparent to those having ordinary skill in the art that aspects of the present invention include many more embodiments. Accordingly, aspects of the present invention are not to be restricted except in light of the attached claims and their equivalents. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

1. A nozzle, comprising:
a throat;
a first expansion section extending downstream of the throat;
a second expansion section extending downstream of the first expansion section;
wherein an inflection point is defined where the first expansion section meets the second expansion section;
wherein the first expansion section has a first contour designed for optimal performance throughout a first altitude range;
wherein the second expansion section has a second contour designed for optimal performance throughout a second altitude range;
wherein the first altitude range and the second altitude range are separated by a third altitude range;
wherein the throat, the first expansion section, and the second expansion section are components of a dual-expansion nozzle portion of the nozzle; and
wherein the nozzle further comprises a secondary nozzle portion downstream of the dual-expansion nozzle portion.

2. (canceled)

3. The nozzle of claim 1, wherein the secondary nozzle portion is formed by a centerbody.

4. The nozzle of claim 1, wherein the first altitude range extends between sea level and a first threshold altitude; and
wherein the first threshold altitude is in a range from 0.1 km to 4 km from sea level.

5. The nozzle of claim 1, wherein the second altitude range extends between a second threshold altitude and a maximum mission altitude;
wherein the second threshold altitude is in a range from 60 km to 100 km from sea level.

6. The nozzle of claim 1, wherein the third altitude range spans a distance of at least 56 km.

7. The nozzle of claim 1, wherein the throat, the first expansion section, and the second expansion section extend annularly about an axis;
wherein the first expansion section is axisymmetric relative to the axis; and
wherein the second expansion section is non-axisymmetric relative to the axis.

8. The nozzle of claim 1, wherein respective exit planes of the first expansion section and the second expansion section are not parallel relative to one another.

9. The nozzle of claim 1, wherein the throat, the first expansion section, and the second expansion section extend annularly about an axis;
wherein the first expansion section is non-axisymmetric relative to the axis; and
wherein the second expansion section is non-axisymmetric relative to the axis.

10. The nozzle of claim 1, wherein the throat, the first expansion section, and the second expansion section extend annularly about an axis; and
wherein the second expansion section includes an upstream portion that is axisymmetric relative to the axis, and a downstream extension portion that is non-axisymmetric relative to the axis.

11-19. (canceled)

20. A heat shield for protecting a windward side of a vehicle from a high enthalpy flow, the heat shield comprising:
a wall defining at least a first portion of an outer heat shield surface on the windward side of the vehicle during exposure to the high enthalpy flow;
wherein the wall includes an opening that defines an exit of a dual-expansion nozzle; and
wherein the wall further includes a bleed opening through which an exhaust fluid exits the heat shield.

21. The heat shield of claim 20, wherein the wall is a thruster mount wall; and
wherein the heat shield further includes a centerbody wall defining a second portion of the outer heat shield surface.

22. The heat shield of claim 21, wherein the thruster mount wall extends annularly about the centerbody wall.

23. The heat shield of claim 22, wherein the thruster mount wall and centerbody wall are at least substantially flush relative to one another.

24. The heat shield of claim 22, wherein the thruster mount wall and the centerbody wall form a blunt body.

25. The heat shield of claim 20, wherein the opening is a first opening among a plurality of thruster openings in the wall;
wherein the dual-expansion nozzle is a first dual-expansion nozzle among a plurality of dual-expansion nozzles; and
wherein each thruster opening in the wall defines an exit of one of the dual-expansion nozzles.

26. The heat shield of claim 25, wherein the wall is a thruster mount wall;
wherein the heat shield further includes a centerbody wall defining a second portion of the outer heat shield surface;
wherein the thruster mount wall extends annularly about the centerbody wall; and
wherein the thruster openings are circumferentially spaced around the thruster mount wall.

27. The heat shield of claim 26, wherein the bleed opening is one of a plurality of bleed openings in the thruster mount wall through which the exhaust fluid exits the heat shield; and
wherein the bleed openings are circumferentially spaced around the thruster mount wall; and
wherein the bleed openings are positioned relative to the thruster openings such that the exhaust fluid exiting each bleed opening influences an exhaust plume exiting a nearby thruster opening.

28. The heat shield of claim 27, wherein each bleed opening is at a circumferential position between two circumferentially-adjacent thruster openings.

29. The heat shield of claim 28, wherein the bleed openings are radially inward of the thruster openings.

30. (canceled)

31. The heat shield of claim 20, wherein the exhaust fluid is a turbine exhaust fluid.

32. The heat shield of claim 20, wherein the bleed opening is configured such that the exhaust fluid exiting therethrough influences an exhaust plume exiting the opening that defines the exit of the dual-expansion nozzle.

33. The heat shield of claim 20, wherein the exit of the dual-expansion nozzle is at least substantially flush with the outer heat shield surface.

34. The heat shield of claim 20, wherein the heat shield is actively-cooled during exposure to the high enthalpy flow.

35-61. (canceled)
